(19) United States
(12) Patent Application Publication
(10) Pub. No.: US 2024/0383111 A1
(43) Pub. Date: Nov. 21, 2024

(54) TOOL SHAFT COMBINATION STRUCTURE OF POWER TOOL

(71) Applicant: BASSO INDUSTRY CORP., Taichung (TW)

(72) Inventors: Chiang HUA, Taichung (TW); Chi-Yung HUANG, Taichung (TW)

(21) Appl. No.: 18/656,873

(22) Filed: May 7, 2024

(30) Foreign Application Priority Data
May 15, 2023 (TW) 112204770

(51) Int. Cl. B25B 23/00

(52) U.S. Cl. CPC B25B 23/0035

(57) ABSTRACT

The disclosure is a power tool. The adaptor head includes a seat, a connecting sleeve, an inserting hole and a rolling ball trench. The inserting hole is disposed in the connecting sleeve. The rolling ball trench communicates with the inserting hole. The rolling balls are movably accommodated in the rolling ball trench and include a lower rolling ball which may partially fall in the inserting hole and upper rolling balls. The upper rolling balls include a front rolling ball and a rear rolling ball. The sleeve includes a blocking block and a buffering trench and moves relative to the seat to make the front rolling ball blocked by the blocking block or fall in the buffering trench. The flexible ring flexibly presses the rear rolling ball.

### BACKGROUND

### Technical Field

The disclosure relates to a power tool, particularly to a tool shaft combination structure of power tool.

### Related Art

Power tools have been applied to fields of home repair, machine manufacture, vehicle repair, etc. and can replace different types of screwdriver bits so as to implement various work requirements and improve work efficiency.

Further, screwdriver bits of power tools are usually configured into a replaceable manner to provide users replacement depending upon different work requirements. Also, screwdriver bits of power tools use a rolling ball for locking and positioning, which is a common combination structure. Connection and torque transfer can be implemented between a main shaft and a screwdriver bit of a power tool by rotation and slide of a rolling ball.

However, during the using process of power tools, a rolling ball is in continuous contact with a screwdriver bit and rolls, this results in continuous friction between the rolling ball and the screwdriver bit to cause wear of the rolling ball to decrease reliability and shorten service life. In addition, power tools require both hands to replace a screwdriver bit, which is inconvenient.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

An object of the disclosure is to provide a tool shaft combination structure of power tool, which reduces wear of the rolling balls and increases reliability to accomplish the objects of connection of the tool shaft and increase of service life.

To accomplish the above object, the disclosure provides a tool shaft combination structure of power tool, used for being inserted to a screwdriver bit whose outer surface has a groove, which includes an adaptor head, multiple rolling balls, a sleeve and a flexible ring. The adaptor head includes a seat, a connecting sleeve extended from the seat, an inserting hole and a rolling ball trench. The inserting hole is disposed in the connecting sleeve and extended into the seat. The rolling ball trench is disposed an outer surface of the seat and communicates with the inserting hole. The multiple rolling balls are movably accommodated in the rolling ball trench and include a lower rolling ball which may partially fall in the inserting hole and multiple upper rolling balls which are superposed on the lower rolling ball and connected to each other. The upper rolling balls include a front rolling ball which is adjacent to the connecting sleeve and a rear rolling ball which is away from the connecting sleeve. The sleeve is movably covered outside the seat and has a blocking block and a buffering trench. The sleeve moves relative to the seat to make the front rolling ball blocked by the blocking block or fall in the buffering trench. The flexible ring flexibly presses the rear rolling ball.

An object of the disclosure is to provide a tool shaft combination structure of power tool, which may use a single hand to replace a screwdriver bit to improve convenience of use.

In comparison with the related art, when the screwdriver bit of the tool shaft combination structure of power tool is inserted into the connecting sleeve, it pushes the lower rolling ball to move rightward (inward) and the lower rolling ball pushes the rear rolling ball to move upward and move in the buffering trench. Next, the lower rolling ball will fall in the groove and the rear rolling ball will move to the original position to position the screwdriver bit. Further, when removing the screwdriver bit, the lower rolling ball moves leftward (outward) and the lower rolling ball pushes the front rolling ball to move upward and partially move in the buffering trench so as to remove the screwdriver bit and make replacement. This prevents the rolling balls from wearing and increases the service life when using the power tool.

### BRIEF DESCRIPTION OF THE DRAWINGS

FIG. 1 is a perspective schematic view of the tool shaft combination structure of power tool of the disclosure;

FIG. 2 is an exploded schematic view of the tool shaft combination structure of power tool of the disclosure;

FIG. 3 is an assembled cross-sectional view of the tool shaft combination structure of power tool of the disclosure;

FIG. 4 is a schematic view of the rolling balls placed in the rolling ball trench of the disclosure;

FIGS. 5-7 are schematic views of actions of the tool shaft combination structure of power tool of the disclosure being inserted into a screwdriver bit; and

FIGS. 8-9 are schematic views of actions of anti-separation and removing from a screwdriver bit of the tool shaft combination structure of power tool of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

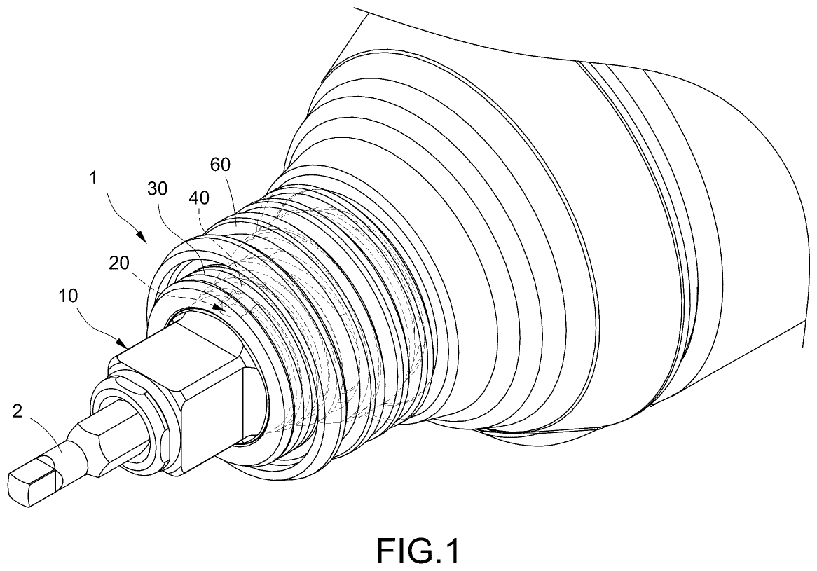

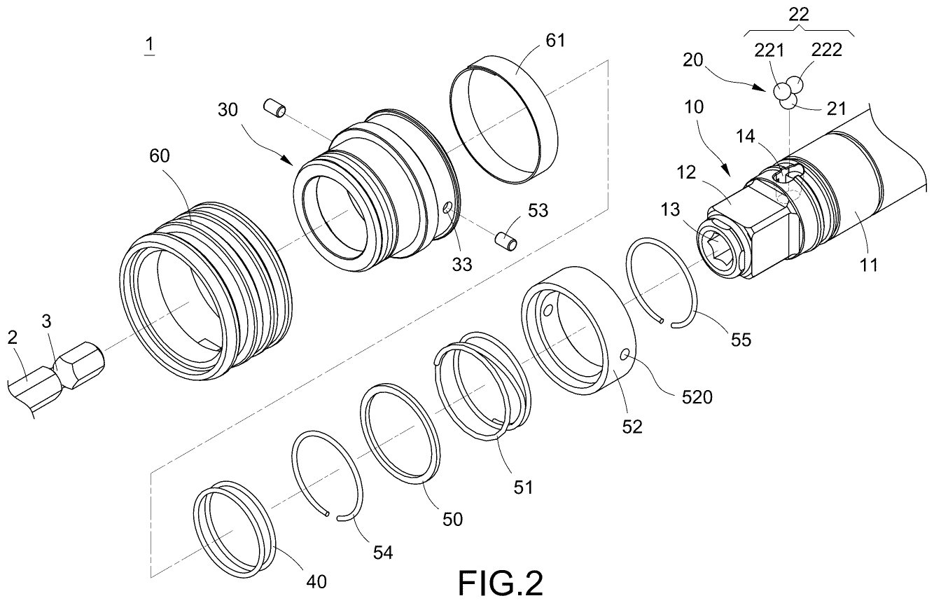

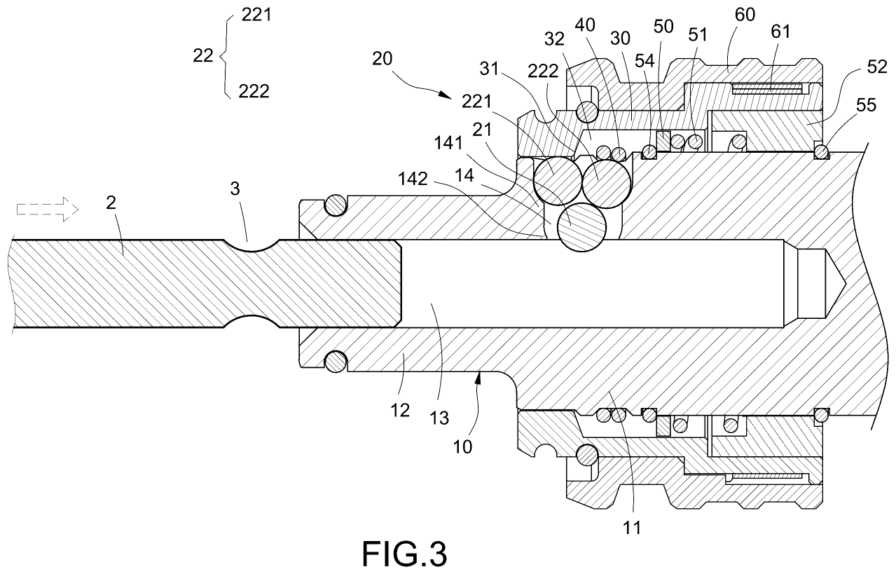

Please refer to FIGS. 1-4, which are a perspective schematic view, an exploded schematic view, an assembled cross-sectional view of the tool shaft combination structure of power tool of the disclosure and a schematic view of the rolling balls placed in the rolling ball trench. The disclosure is a tool shaft combination structure 1 of power tool, used for being inserted to a screwdriver bit 2 whose outer surface has a groove 3, which includes an adaptor head 10, multiple rolling balls 20, a sleeve 30 and a flexible ring 40. The rolling balls 20 are disposed on the adaptor head 10 and flexibly pressed by the flexible ring 40. The sleeve 30 is disposed around the adaptor head 10 so as to make the rolling balls 20 movably disposed between the adaptor head 10 and the sleeve 30. The tool shaft combination structure 1 of power tool will be further described as follows.

The adaptor head 10 includes a seat 11, a connecting sleeve 12 extended from the seat 11, an inserting hole 13 and a rolling ball trench 14. The inserting hole 13 is disposed in the connecting sleeve 12 and extended into the seat 11. The rolling ball trench 14 is disposed an outer surface of the seat 11 and communicates with the inserting hole 13.

The multiple rolling balls 20 are movably accommodated in the rolling ball trench 14 and include a lower rolling ball 21 which may partially fall in the inserting hole 13 and multiple upper rolling balls 22 which are superposed on the lower rolling ball 13 and connected to each other. The upper rolling balls 22 include a front rolling ball 221 which is adjacent to the connecting sleeve 12 and a rear rolling ball 222 which is away from the connecting sleeve 12.

Furthermore, the sleeve 30 is movably covered outside the seat 11 and has a blocking block 31 and a buffering trench 32. Also, the sleeve 30 moves relative to the seat 11 to make the front rolling ball 221 blocked by the blocking block 31 or fall in the buffering trench 32 to abut against the groove 3 of the screwdriver bit 2.

In addition, the flexible ring 40 flexibly presses the rear rolling ball 222. In the embodiment, the flexible ring 40 is multiple in number. The multiple flexible rings 40 connectively press the rear rolling ball 222

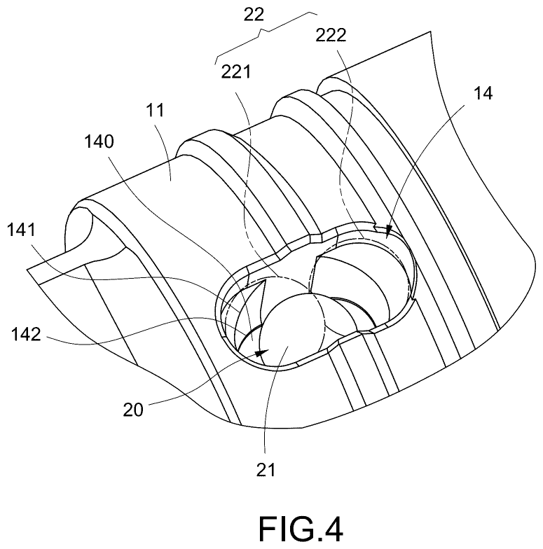

In detail, the rolling ball trench 14 is an oval trench and includes a passing hole 140, a protrusion 141 formed on an inner wall of the passing hole 140 and a flange 142 located on the bottom of the passing hole 140 (referring to FIG. 4). Also, the upper rolling balls 22 abut against the protrusion 141. The lower rolling ball 21 is blocked by the flange 142 not to escape from the rolling ball trench 14. In detail, the rolling ball trench 14 has an elongated opening which is slightly greater than the diameter length of the lower rolling ball 21 and less than the diameter length of the upper rolling balls 22 connected. As a result, the upper rolling ball 22 superposed on the upper layer of the rolling ball trench 14 will not fall in the position of the lower layer of the rolling ball trench 14.

In an embodiment of the disclosure, the tool shaft combination structure 1 of power tool further includes a limiting ring 50, a spring 51, a blocking ring 52 and a pair of inserts 53. The limiting ring 50 is placed around/outside the seat 11 and abuts against an end of the spring 51. The blocking ring 52 is connected between the seat 11 and the sleeve 30 and abuts against the other end of the spring 51.

In detail, the sleeve 30 is disposed with a pair of through holes 33. The blocking ring 52 is disposed with a pair of positioning holes 520. The sleeve 30 and the blocking ring 52 use the pair of inserts 53 to pass through the pair of through holes 33 and the pair of positioning holes 520 to be connected.

In addition, the tool shaft combination structure 1 of power tool further includes a front C-ring 54 and a rear C-ring 55. The front C-ring 54 is disposed on a side of the limiting ring 50, which is away from the spring 51. The rear C-ring 55 is disposed on a side of the blocking ring 52, which is away from the spring 51.

In the embodiment, the tool shaft combination structure 1 of power tool further includes an outer sleeve 60 and an elastic sheet 61. The outer sleeve 60 is placed around the sleeve 30 to be advantageous to exerting force and driving the sleeve 30 to move. Also, the elastic sheet 61 is disposed between the outer sleeve 60 and the sleeve 30 to increase the connectivity therebetween and guarantee both the outer sleeve 60 and the sleeve 30 to move together.

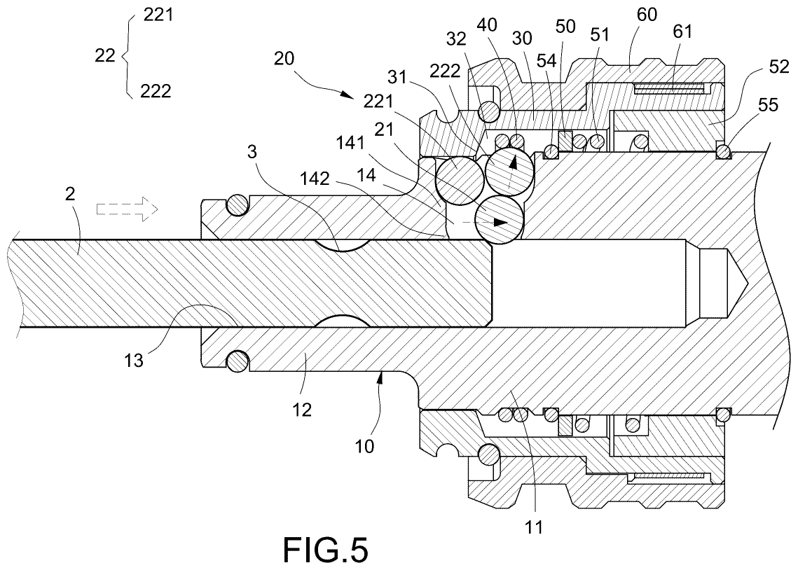

Please refer to FIGS. 5-7, which are schematic views of action of the tool shaft combination structure of power tool of the disclosure being inserted into a screwdriver bit. As shown in FIG. 5, the tool shaft combination structure 1 of power tool of the disclosure is used for being inserted to a screwdriver bit 2 whose outer surface has a groove 3. A distal end of the screwdriver bit 2 pushes the lower rolling ball 21 to move rightward (inward) and the lower rolling ball 21 pushes the rear rolling ball 222 to move upward when the screwdriver bit 2 is inserted into the inserting hole 13 of the connecting sleeve 12 and stretches to the position of the rolling ball trench 14.

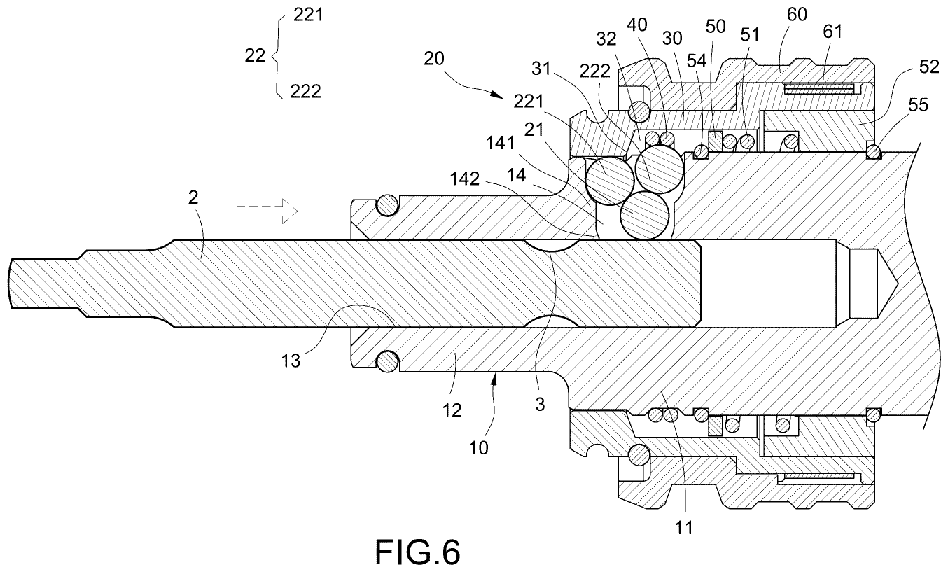

Next, as shown in FIG. 6, the screwdriver bit 2 keeps moving inward, the rear rolling ball 222 will pushes and expands the flexible ring 40 to project from the rolling ball trench 14 to be partially located in the buffering trench 32.

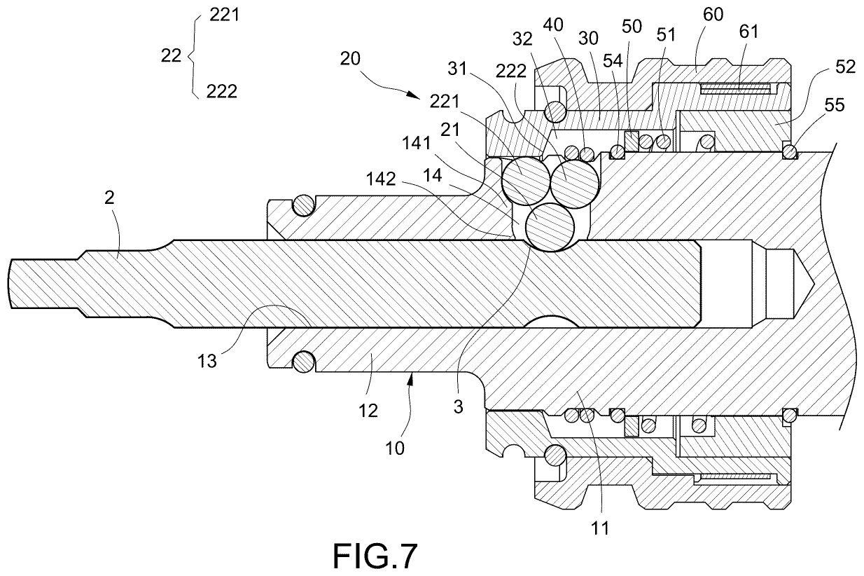

Next, as shown in FIG. 7, after the groove 3 of the screwdriver bit 2 moves to the position of the rolling ball trench 14, the lower rolling ball 21 will fall in the groove 3 and the rear rolling ball 222 will move to the original position. Thus, the flexible ring 40 returns to the original shape so as to make the screwdriver bit 2 positioned in the inserting hole 13.

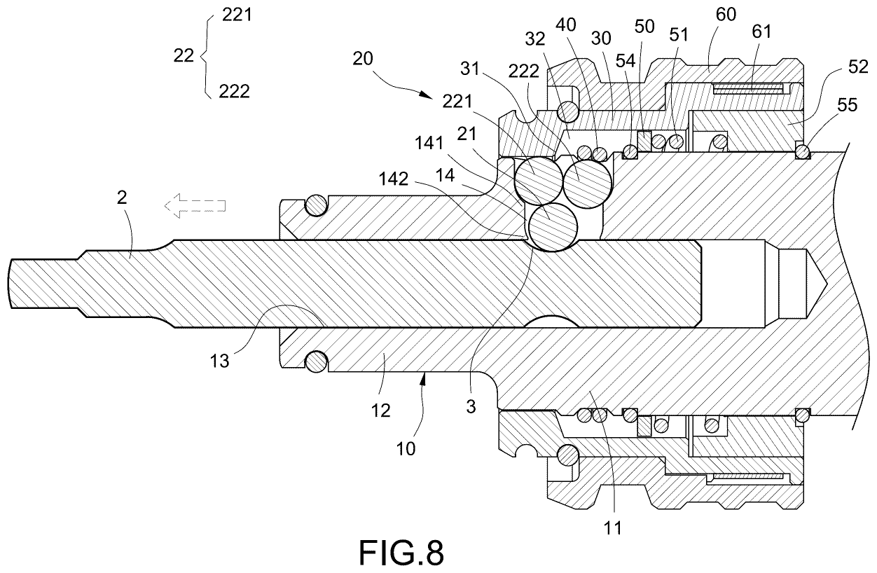

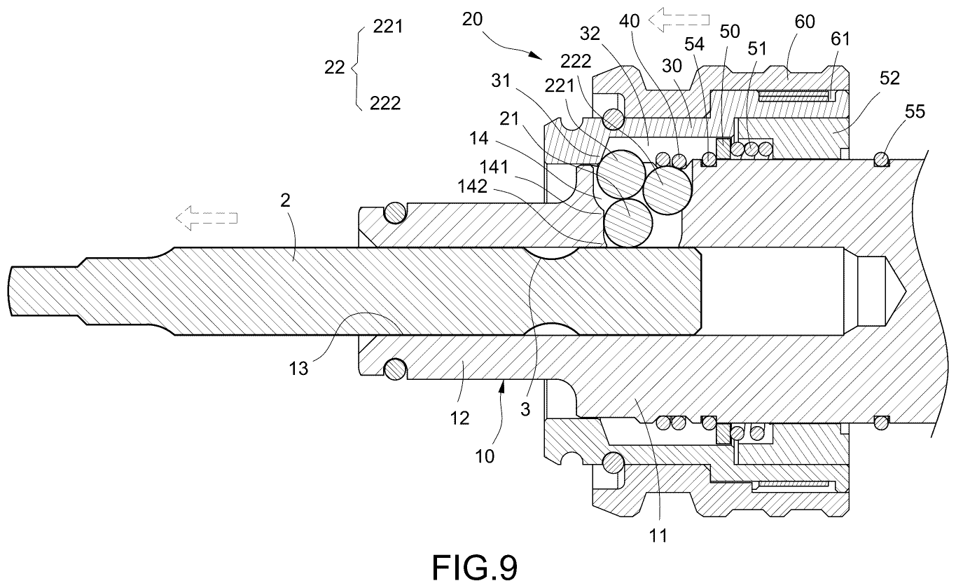

Please refer to FIGS. 8-9, which are schematic views of action of anti-separation and removing from a screwdriver bit of the tool shaft combination structure of power tool of the disclosure. The tool shaft combination structure 1 of power tool of the disclosure may be inserted to different types of screwdriver bits. The screwdriver bit 2 in the inserting hole 13 must be withdrawn to be advantageous to replacement.

As shown in FIG. 8, the tool shaft combination structure of power tool of the disclosure may prevent the screwdriver bit 2 from unexpectedly separating. When the screwdriver bit 2 is removed by an external force, the lower rolling ball 21 moves leftward (outward) and the lower rolling ball 21 pushes the front rolling ball 221 to move upward. At this time, the front rolling ball 221 is limited by the blocking block 31 of the sleeve 30 not to make the lower rolling ball 21 escape from the groove 3 so as to accomplish the object of preventing the screwdriver bit 2 from separating.

Furthermore, as shown in FIG. 9, when a user needs to remove the screwdriver bit 2, a force is exerted on the outer sleeve 60 to move the sleeve 30 leftward (outward). In addition, the screwdriver bit 2 keeps leftward (outward) removing from the inserting hole 13, the lower rolling ball 21 will push the front rolling ball 221 to move upward and partially move in the buffering trench 32. At this time, the lower rolling ball 21 will escape from the positioning to the groove 3. Thus, the screwdriver bit 2 removes from the inserting hole 13 and the inserting hole 13 may be further inserted to another screwdriver bit for replacement.

While this disclosure has been described by means of specific embodiments, numerous modifications and variations could be made thereto by those skilled in the art without departing from the scope and spirit of this disclosure set forth in the claims.

What is claimed is:

1. A tool shaft combination structure of power tool, used for being inserted to a screwdriver bit whose outer surface comprises a groove, comprising:
an adaptor head, comprising a seat, a connecting sleeve extended from the seat, an inserting hole and a rolling ball trench, the inserting hole being disposed in the connecting sleeve and extended into the seat, and the rolling ball trench being disposed an outer surface of the seat and communicating with the inserting hole;
multiple rolling balls, movably accommodated in the rolling ball trench, comprising a lower rolling ball which partially falls in the inserting hole and multiple upper rolling balls which are superposed on the lower rolling ball and connected to each other, and the upper rolling balls comprising a front rolling ball which is adjacent to the connecting sleeve and a rear rolling ball which is away from the connecting sleeve;
a sleeve, movably covered outside the seat, comprising a blocking block and a buffering trench, moving relative to the seat to make the front rolling ball blocked by the blocking block or fall in the buffering trench; and
a flexible ring, flexibly pressing the rear rolling ball.

2. The tool shaft combination structure of power tool of claim 1, wherein the rolling ball trench comprises a passing hole, a protrusion formed on an inner wall of the passing hole and a flange located on a bottom of the passing hole, the upper rolling balls abut against the protrusion, and the lower rolling ball is blocked by the flange not to escape from the rolling ball trench.

3. The tool shaft combination structure of power tool of claim 1, wherein the rolling ball trench is an oval trench, the rolling ball trench comprises an elongated opening which is greater than a diameter length of the lower rolling ball and less than a diameter length of the upper rolling balls connected.

4. The tool shaft combination structure of power tool of claim 1, further comprising a limiting ring and a spring, and the limiting ring is placed around the seat and abuts against an end of the spring.

5. The tool shaft combination structure of power tool of claim 1, further comprising a blocking ring, and the blocking ring is connected between the seat and the sleeve and abuts against another end of the spring.

6. The tool shaft combination structure of power tool of claim 5, further comprising a front C-ring and a rear C-ring, wherein the front C-ring is disposed on a side of the limiting ring, which is away from the spring, and the rear C-ring is disposed on a side of the blocking ring, which is away from the spring.

7. The tool shaft combination structure of power tool of claim 5, further comprising a pair of inserts, wherein the sleeve is disposed with a pair of through holes, the blocking ring is disposed with a pair of positioning holes, and the sleeve and the blocking ring use the pair of inserts to pass through the pair of through holes and the pair of positioning holes to be connected.

8. The tool shaft combination structure of power tool of claim 1, further comprising an outer sleeve placed around the sleeve.

9. The tool shaft combination structure of power tool of claim 8, further comprising an elastic sheet disposed between the outer sleeve and the sleeve.

10. The tool shaft combination structure of power tool of claim 1, wherein the flexible ring is multiple in number, and the multiple flexible rings connectively press the rear rolling ball.

11. The tool shaft combination structure of power tool of claim 2, wherein the rolling ball trench is an oval trench, the rolling ball trench comprises an elongated opening which is greater than a diameter length of the lower rolling ball and less than a diameter length of the upper rolling balls connected.
